(19) United States
(12) Patent Application Publication
(10) Pub. No.: US 2005/0104718 A1
(43) Pub. Date: May 19, 2005

(54) Automated preparation of radio-frequency devices for distribution

(75) Inventors: Fred C. Casto, Omaha, NE (US); Scott J. Smith, Omaha, NE (US); Jeffrey G. Nowlin, Council Bluffs, IA (US); John E. Christensen, Omaha, NE (US); Jay E. Greene, Omaha, NE (US); Timothy J. Walpus, Omaha, NE (US); Sunil Dewan, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/718,481

(22) Filed: Nov. 19, 2003

(51) Int. Cl. H04Q 5/22

(52) U.S. Cl. 340/10.1

(57) ABSTRACT

RF devices are received that include embedded radio-frequency transponders. Each RF device is moved sequentially to stations of a preparation device. At one station, an RF identification code assigned to the RF device is encoded. A recipient of the RF device is identified. At another station, a package containing the RF device is labeled with a mailing address for the recipient

### BACKGROUND OF THE INVENTION

This application relates generally to radio-frequency (“RF”) devices. More specifically, this application relates to automated preparation of RF devices for distribution.

An RF device is a device that incorporates the use of electromagnetic or electrostatic coupling in the radio-frequency portion of the electromagnetic spectrum to provide a unique identification signal. The specific portion of the spectrum that is used may depend on a particular application, varying from low-frequency RF devices that operate at about several kHz, to higher-frequency RF devices that may operate at GHz levels; the transmission range is greater with higher frequencies, although devices that operate at such frequencies tend to be more costly.

In recent years, the ability to use radio-frequency transmissions to provide a unique identification signal has been exploited to provide an alternative to other identification systems, such as bar codes and the like. There have increasingly been efforts to expand the use of RF more widely, integrating it into financial-transaction systems as an alternative mechanism for identifying credit or debit accounts, for example. In this way, an RF identification code may substitute for information that has more traditionally been stored on the magnetic stripe of a magnetic-stripe card. A typical RF device typically includes an RF transponder that responds to radio-frequency waves emitted by a transceiver. Because the transponder may be relatively small, it may conveniently be integrated into a wide variety of objects rather than being limited to a standard structure as has been the case for a magnetic-stripe card. For example, RF transponders may conveniently be included in key fobs, baseball caps, necklaces, and a variety of other types of objects, and these different types of objects may be useful for different types of transactions.

While this versatility is useful in providing a diverse array of transaction options, it has proved difficult to accommodate the production of the different types of objects as RF devices. Currently, encoding of such RF devices is typically performed in one of two ways. In some instances, the RF devices are encoded prior to distribution in a highly manual fashion. A device is received in a package at a processing center, where it is removed manually, scanned for encoding, replaced back in the package manually, and distributed. This process involves a significant manual component, and is consequently slow and costly. In other instances, the attempt to encode the RF devices prior to distribution is circumvented by shifting the burden of performing the encoding at a point of distribution. For example, devices may be provided to a retail outlet for purchase by customers, with the encoding being performed only upon such purchase. This approach is generally less convenient for customers, particularly for certain types of RF devices, and may be implemented with less uniformity.

There is accordingly a need in the art for methods that improve automating the preparation of RF devices, particularly that may accommodate a variety of different types of objects.

### BRIEF SUMMARY OF THE INVENTION

Embodiments of the invention thus provide for automated preparation of RF devices for distribution. A plurality of RF devices are received, each such RF device comprises an embedded radio-frequency transponder. Each of the RF devices is moved sequentially to a plurality of stations of a preparation device. At a first station, an RF identification code assigned to the RF device is encoded. A recipient of the RF device is identified. At a second station, a package containing the RF device is labeled with a mailing address for the recipient.

In some embodiments, the RF identification code may be read from the RF device at a third station, which allows verifying that the RF identification code matches the assigned RF identification code. In some instances, radio-frequency shielding may be provided —in some embodiments, such shielding is provided around at least the first station and, in other embodiments, such shielding is provide around the preparation device.

There are a variety of different ways for receiving the plurality of RF devices in different embodiments. For example, in some embodiments, each RF device is received in an enclosure, with the RF identification code being encoded without removing the RF device from the enclosure. In one embodiment, this enclosure is the package labeled with the mailing address. In other embodiments, each RF device is encapsulated in material to produce a structure of a standard size, with the preparation device adapted to move objects of the standard size to the plurality of stations. The devices may be encapsulated by heat shrink wrapping, in one embodiment. In another embodiment, each RF device is affixed to a backboard having a standard size, with the preparation device adapted to move objects of the standard size to the plurality of stations. In a further embodiment, the RF devices may be comprised by a reel that includes a plurality of such devices. The reel may be cut at one of the stations between RF devices to separate the devices.

In some embodiments, the RF devices may be provided with magnetic-stripe cards. A plurality of magnetic-stripe cards is received, and an identification of each magnetic-stripe card is read from its magnetic stripe at a third station. The RF identification code to be assigned to a corresponding RF device is determined from the magnetic-stripe identification. The package labeled for mailing to the recipient may include the magnetic-stripe card and the corresponding RF device.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic illustration of one embodiment of a system providing automated preparation of RF devices for distribution;

FIG. 2 is a flow diagram illustrating a method for automated preparation of RF devices for distribution using the system of FIG. 1;

FIG. 3 is a schematic illustration of another embodiment of a system providing automated preparation of RF devices for distribution;

FIG. 4 is a flow diagram illustrating a method for automated preparation of RF devices for distribution using the system of FIG. 3;

FIG. 5 is a schematic illustration of a further embodiment of a system providing automated preparation of RF devices for distribution;

FIG. 6 is a flow diagram illustrating a method for automated preparation of RF devices for distribution using the system of FIG. 5; and

FIG. 7 is a schematic illustration of a controller that may be used with the automated systems in embodiments of the invention.

### DETAILED DESCRIPTION OF THE INVENTION

Embodiments of the invention provide for automated preparation of RF devices for distribution. In many of the embodiments, existing equipment suitable for the preparation of magnetic-stripe cards may be used without significant modification, even though the RF devices may have different sizes and shapes from magnetic-stripe cards.

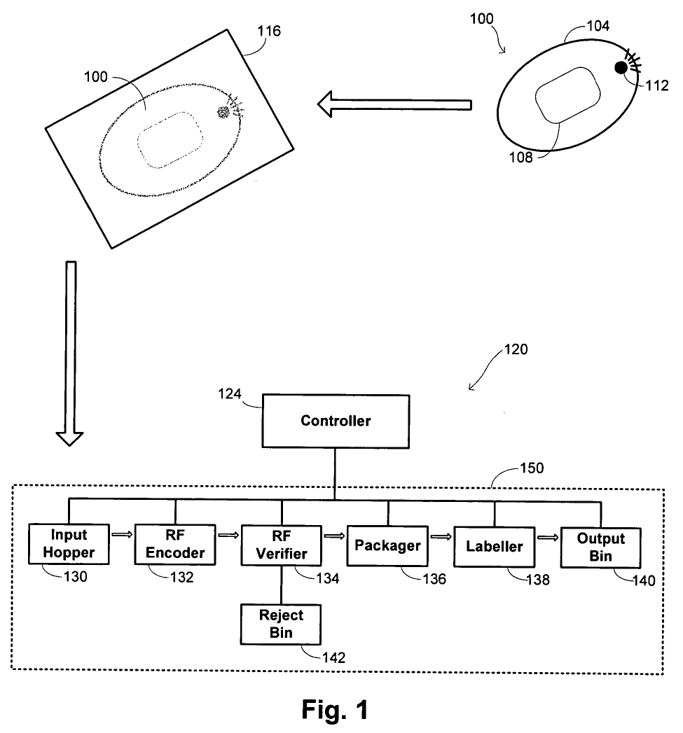

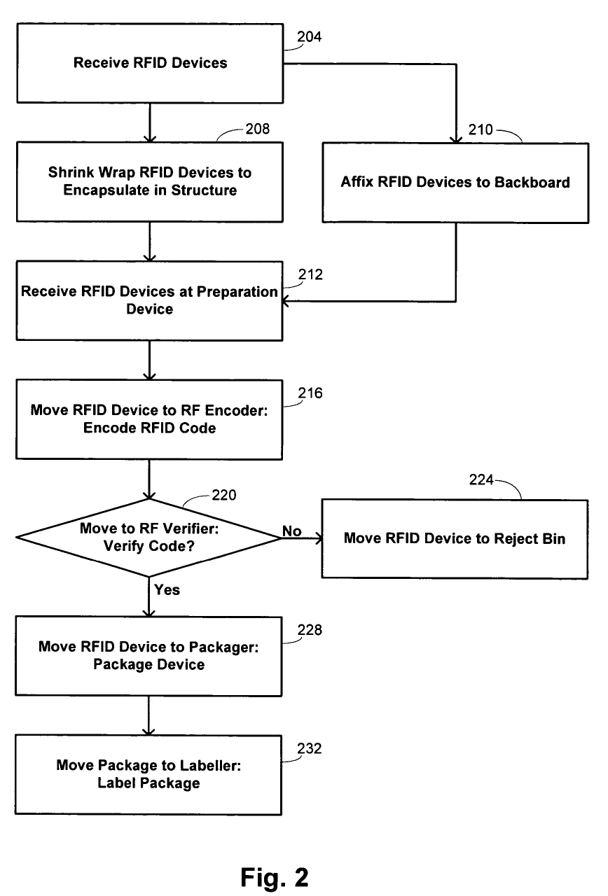

An example of one system for preparing RF devices is provided in FIG. 1, which is accompanied by the flow diagram of FIG. 2 illustrating a method using the system of FIG. 1. The description that follows thus makes simultaneous reference to FIGS. 1 and 2. The illustrated embodiments make use of techniques to encapsulate the RF device in a package having a standard size, allowing the RF device to be prepared for distribution using existing equipment already adapted for preparation of objects having that size. For example, in the illustration, the RF device is a fob 100, and is prepared using a modification of equipment suitable for preparation of magnetic-stripe cards. The structure of the fob 100 itself may include a housing 104 having an activation button 108 and enclosing a RF transponder 112. When encoded, such a fob 100 may be used to engage in certain financial transactions by providing the fob near an RF reader and activating it with the activation button 108. A code read from the fob 100 is then used to identify a financial account to be used in the transaction. Typically, a plurality of such devices may be received, as indicated at block 204 of FIG. 2.

Each of the plurality of devices is encapsulated in material to produce a package 116 having a standard size, as shown in FIG. 1. Encapsulation of the devices does not interfere with the ability to address the RF transponders 112 within the devices because the encapsulating material is selected to be substantially transparent at radio frequencies. For example, as indicated at block 208 of FIG. 2, encapsulation of the device 100 may be performed by a shrink-wrapping technique to produce a structure having a size that is about the same as a conventional magnetic-stripe card. In some instances, existing equipment may be modified as described herein based on only two dimensions of the encapsulated device, such as where the package 116 has the same length and width dimensions of a magnetic-stripe card, but has a different thickness. For instance, such two-dimensional sizes could be approximately 2.5″×3″, could be approximately 3″×5″, or any other convenient standard size. In other embodiments, the standard size could additionally specify a thickness.

In an alternative embodiment indicated at block 210 of FIG. 2, the device may instead be affixed to a backboard having a standard size rather than being encapsulated. For example, the backboard may be sized similarly to a magnetic-stripe card, thereby again providing a the device as part of a standard-sized unit.

Irrespective of how the standard-sized unit is produced, either by encapsulation or by affixing the device to a standard-sized backboard, each RF device is received at a preparation device 120 as indicated at block 212 of FIG. 2. The preparation device 120 may have a plurality of stations that are each adapted to perform a particular function. One or more of the stations, particularly those involved with specific functions using radio-frequency transmissions, may be enclosed within radio-frequency shielding 150. The operation of each station may be managed by a controller 124 that is also programmed to coordinate the movement of the encapsulating packages to the different stations as part of an automated process. The RF devices may be received by an input hopper 130 of the preparation device 120, from which it may be directed to different stations in accordance with instructions provided by the controller 124. FIG. 1 illustrates one particular sequence of stations to which the RF devices may be directed in a particular embodiment, but this illustration is not intended to be exclusive. In other embodiments, some of the stations may be bypassed, additional stations may be included, or the order in which stations are visited may be changed.

In the illustrated embodiment, each RF device is initially moved to an RF encoder station 132, which is configured to encode the RF device with a particular RF identification code assigned to that device. This station will thus typically include a radio-frequency transceiver and an antenna to allow radio-frequency signals to be exchanged with the transponder 112 of the RF device and to identify the specific device. A database comprised by or accessible by the controller 124 includes an identification of the particular RF identification code to be assigned to the specific device, allowing that code to transmitted to the transponder 112 with the antenna at the RF encoder station 132 as indicated at block 216 of FIG. 2. The database may additionally correlate the assigned RF identification code with a particular individual, such as an anticipated recipient of the device. In some instances, the code may be further correlated with one or more financial accounts to enable the device to be used in providing access to such financial accounts.

In some embodiments, a check may be made to ensure that the RF identification code was correctly written to the transponder 112 by moving the RF device to an RF verifier station 134 as indicated at block 220. This station may also include an antenna and transceiver to allow exchange of radio-signal information with the device's transponder. The transponder is activated at the station, and an identification signal that purports to include the RF identification code is transmitted to the station. A check is made whether the received RF identification code matches the code assigned to that RF device by having the controller 124 check the database records of the assigned code and performing a comparison. In some instances, the RF encoder and RF verifier stations 132 and 134 may be the same station, but in other embodiments they are different stations. If the RF identification code written to the RF device is not successfully verified, the RF device may be moved to a reject bin 142, allowing the device to be discarded in the event that the transponder 112 is defective.

If the RF identification code is verified, the RF device may be moved to a packager station 136 where it may be packaged as indicated at block 228. In some embodiments, it may be packaged within an envelope, particularly if the device is sufficiently small. The package may be labeled at block 232 by moving it to a labeler 138; in some embodiments, such labeling may be unnecessary, such as where packaging the device provides automatic labeling through an envelope window. The prepared RF device is then moved to an output bin 140, from which the devices may be distributed to customers.

In a particular set of embodiments, usually where the size of the RF devices is small, the RF devices may be provided on a reel. This may be suitable, for example, where the RF devices comprise individual chips. The reel may conveniently be fed through the stations of the preparation device 120, which may additionally include a station equipped to separate the RF devices. For example, such a station could be equipped with a cutting tool to cut the reel between RF devices, advantageously using a known separation distance between devices defined by the structure of the reel.

In some embodiments, it may be desirable to prepare an RF device for distribution in combination with a magnetic-stripe card. Such embodiments may be especially useful, for example, in cases where the RF device is intended to be used in connection with financial transactions, recognizing that many points of sale may be equipped only with more traditional magnetic-stripe readers and not with RF readers. Providing a combination of an RF device, such as a fob, with a magnetic-stripe card gives the recipient the flexibility to choose which instrument to use in a given transaction. At those places equipped with RF readers, the more convenient RF device may be used, but it remains possible to enter into transactions using the same financial accounts by using the magnetic-stripe card if a merchant is equipped only to accept magnetic-stripe cards.

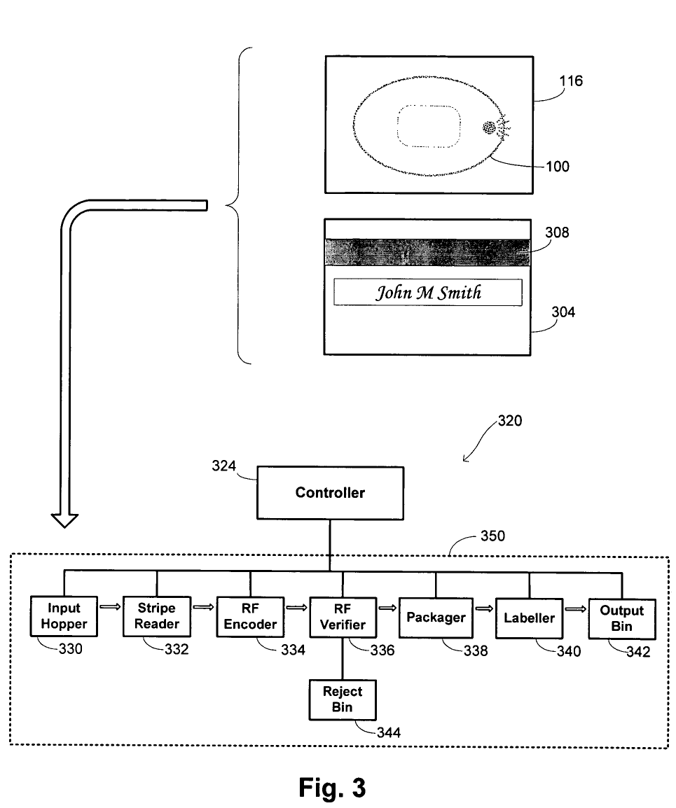

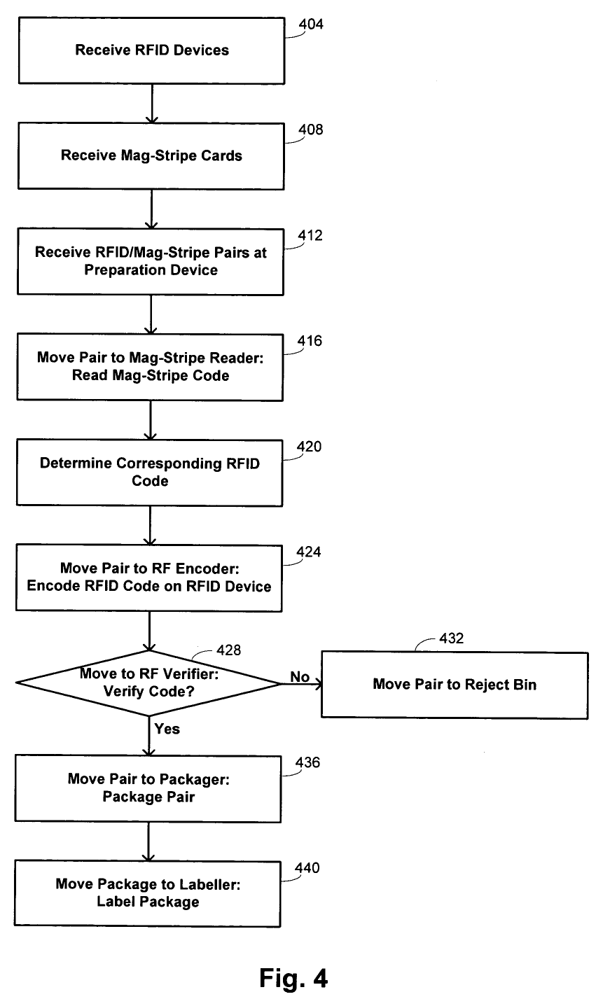

Thus, FIG. 3 provides an example of a system equipped to prepare RF devices in combination with magnetic-stripe devices. It is accompanied by the flow diagram of FIG. 4 illustrating a method using the system of FIG. 3. The description that follows thus makes simultaneous reference to FIGS. 3 and 4. As indicated at blocks 404 and 408 of FIG. 4, the RF devices 100 and the magnetic-stripe devices 304 are received. In some instances, as described above, a standard size may be provided for the RF devices 100 by encapsulating them within material of the standard size or by affixing them to backboards of the standard size. The illustration of the magnetic-stripe card 304 in FIG. 3 shows the back of such a card where the magnetic stripe 308 and a signature of a cardholder are provided.

The RF devices and the magnetic-stripe cards are paired as indicated in FIG. 3 so that pairs comprising an RF device and a magnetic-stripe card may be received by the preparation device 320 at block 412 of FIG. 4. Similar to the preparation device shown in FIG. 1, the preparation device 320 may have a plurality of stations at which specific functions may be performed, with functions and movement of the pairs between stations being managed by a controller 324. Again, in some embodiments, one or more of the stations may be enclosed within radio-frequency shielding 150. The sequence of stations illustrated in FIG. 3 is not intended to be limiting, nor is it intended to indicate exclusively which functions may be performed on the RF-device/magnetic-stripe-card pairs.

The pairs may be received at an input hopper 330 and may be moved together as a pair through the different stations as indicated in the embodiment of FIG. 4, or may be moved along separate paths with the controller 324 tracking the positions of the separate elements of each pair. At block 416, the pair is moved to a magnetic-stripe reader station 332, which is equipped to read information from the magnetic stripe 308 on the magnetic-stripe card 304. This information is used by the controller at block 420 to identify a corresponding RF identification code, such as through a database lookup table; in some instances, the database lookup table may include intermediate information used in identifying the corresponding RF identification code, such as the identity of a recipient.

The RF identification code corresponding to the magnetic-stripe code extracted from the magnetic-stripe card is encoded onto the RF device at block 424 by moving the pair to an RF encoder station 334. Such a station includes a transceiver and antenna to enable radio communications with the transponder of the RF device so that the corresponding code may be written to the RF device. In some instances, a verification may be performed at block 428 to ensure that the code is written to the device correctly. In some instances, this verification may be performed at the same station, but in other embodiments it is performed by moving the pair to a separate RF verification station 336, also equipped with a transceiver and antenna to enable exchange of radio-frequency information. The verification is performed by reading the RF identification code from the RF device and comparing it with records of the assigned RF identification code accessible to the controller. If the code is not verified, the RF-device/magnetic-stripe-card pair may be moved to a reject bin 344 as indicated at block 432.

If the code is verified, the pair may be packaged at block 436 at a packager station 338 and the package may be labeled at block 440 at a labeler station 340. In one embodiment, the pair are conveniently packaged within an envelope for delivery to a recipient. The packaged pair may conveniently be deposited in an output bin 342 by the preparation device, from which it may be distributed to the recipient.

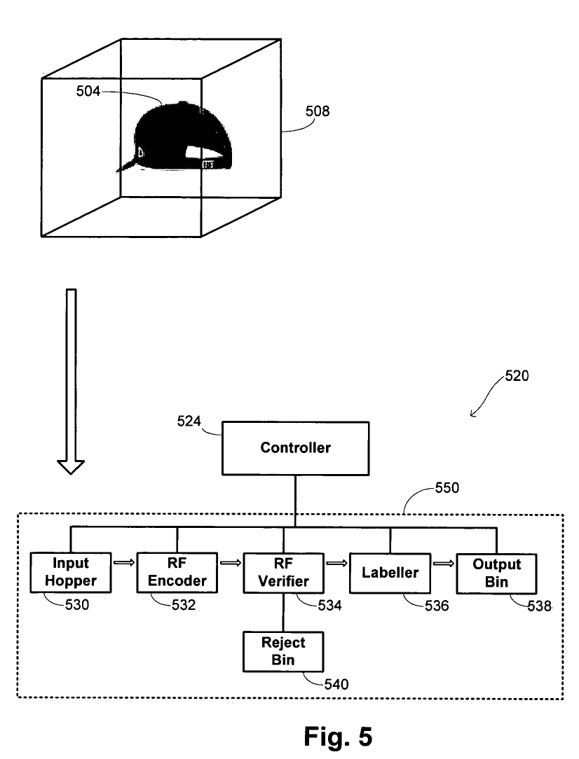

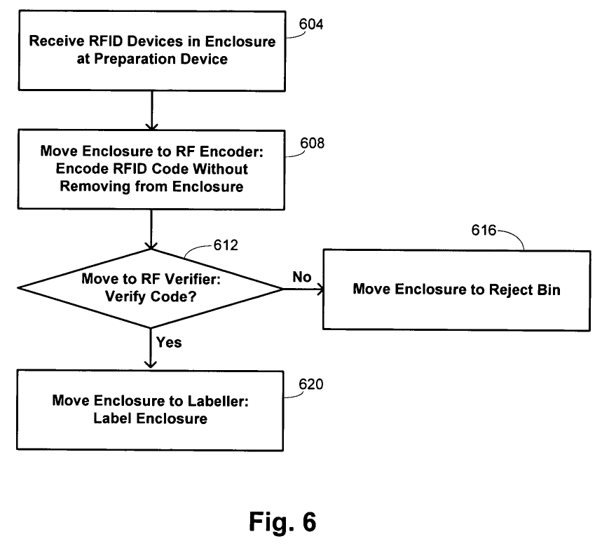

In still other embodiments, the methods of the invention may be applied to RF devices that may initially be received in enclosures. This may be true, for example, where the RF devices are to be sold to customers in the enclosures or where the RF devices are larger. For instance, an RF device may be provided as a stored-value instrument that takes the form of a baseball cap. Such a device could be provided for sale to children at an amusement park, enabling the child to wear the cap and have value decremented automatically as he partakes in amusements. The form of the devices is virtually endless and may include such things as necklaces, bracelets, shoes, teddy bears, etc. FIG. 5 provides an illustration of a system that is suitable for preparing such RF devices, and is accompanied by the flow diagram of FIG. 6 illustrating a method for using the system of FIG. 5. The following description therefore makes reference to both FIGS. 5 and 6.

The example used for the RF device in FIG. 5 is a baseball cap 504, which is shown schematically to be enclosed within a box 508. More realistically, the box enclosure 508 would contain packing material to protect the item, but such material should not interfere with the preparation operations since it will generally be transparent at radio frequencies. As indicated at block 604 of FIG. 6, the enclosure is received at a preparation device 520, such as in the input hopper 530 identified in FIG. 5. The preparation device 520 is equipped to move the enclosure to a plurality of stations where preparation functions may be executed, and may include radio-frequency shielding 550, particularly around those stations whose functions use radio-frequency transmissions. In some embodiments, the structure of the preparation device 520 may be designed to accommodate enclosures having certain predefined sizes, although in other embodiments a variation of enclosure sizes may be accommodated by using position-recognition techniques, such as cameras, position sensors, and the like. The sequence of stations illustrated for the preparation device 520 in FIG. 5 is not intended to be limiting; in other embodiments, more or fewer stations may be provided and/or the stations may be encountered in a different order. A controller 524 is provided to coordinate movement of the enclosures and to control operations performed on the enclosures at the different stations.

Thus, similar to other embodiments described above, the enclosure may be moved at block 608 to an RF encoder station 532 equipped with a transceiver and antenna for exchanging radio-frequency information with the RF device. Using techniques similar to those described above, the RF device is encoded with an assigned RF identification code as determined by the controller 524. Such encoding is performed without removing the RF device from the enclosure. In embodiments where a verification is performed to ensure that the correct RF identification code has been written to the RF device, the enclosure may be moved at block 612 to an RF verifier station 534 that is also equipped with a transceiver and antenna for communication with a transponder in the RF device. The RF verifier station 534 requests identification of code written to the RF device so that it may be compared by the controller 524 with the code that was to have been assigned. In other embodiments, the verification and encoding functions may be performed at a single station. If the verification fails, the enclosure may be moved at block 616 to a reject bin. If the verification confirms that the correct code has been written, however, the enclosure may be moved at block 620 to a labeler so that a recipient may be identified. Because the RF device is already packaged in the enclosure 508, it may be sufficient simply to label the enclosure 508 at block 620 at a labeler station 536 without needing to package the enclosure 508 further. The labeled enclosure may then be directed to an output bin 538, from which it may be distributed to a recipient.

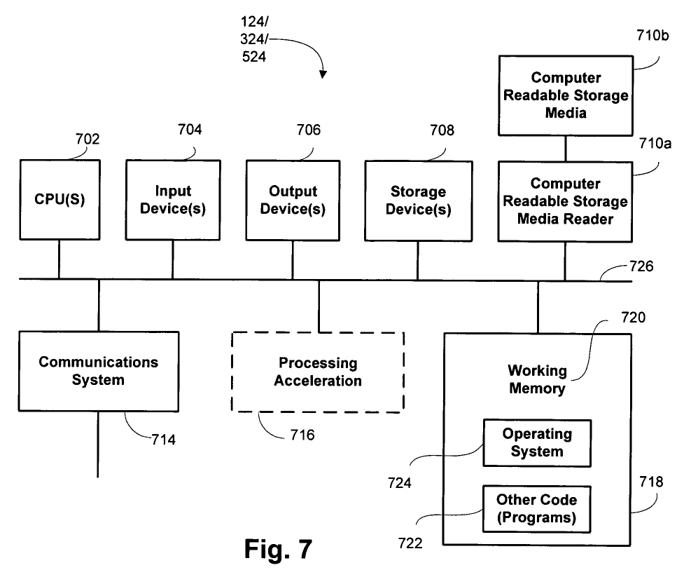

FIG. 7 provides a schematic illustration of a structure that may be used to implement the host system controller 124, 324, or 524 in any of the preceding embodiments. FIG. 7 broadly illustrates how individual system elements may be implemented in a separated or more integrated manner. The controller is shown comprised of hardware elements that are electrically coupled via bus 726, including a processor 702, an input device 704, an output device 706, a storage device 708, a computer-readable storage media reader 710a, a communications system 714, a processing acceleration unit 716 such as a DSP or special-purpose processor, and a memory 718. The computer-readable storage media reader 710a is further connected to a computer-readable storage medium 710b, the combination comprehensively representing remote, local, fixed, and/or removable storage devices plus storage media for temporarily and/or more permanently containing computer-readable information. The communications system 714 may comprise a wired, wireless, modem, and/or other type of interfacing connection and permits data to be exchanged with other devices. Records of assigned RF identification codes, lookup tables for corresponding magnetic-stripe cards, and the like may be stored on the storage device 708, or may accessible from remote storage through the communications system 714.

The controller also comprises software elements, shown as being currently located within working memory 720, including an operating system 724 and other code 722, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method for automated preparation of radio-frequency devices for distribution, the method comprising:
receiving a plurality of such radio-frequency devices, each such device comprising an embedded radio-frequency transponder;
sequentially moving each of the radio-frequency devices to a plurality of stations of a preparation device;
encoding, at a first station, a radio-frequency identification code assigned to the each of the radio-frequency devices;
identifying a recipient for the each of the radio-frequency devices; and
labeling, at a second station, a package containing the each of the radio-frequency devices with a mailing address for the recipient.

2. The method recited in claim 1 further comprising:
reading, at a third station, the radio-frequency identification code from the each of the radio-frequency devices; and
verifying that the read radio-frequency identification code matches the assigned radio-frequency identification code.

3. The method recited in claim 1 further comprising providing radio-frequency shielding around at least the first station.

4. The method recited in claim 1 further comprising providing radio-frequency shielding around the preparation device.

5. The method recited in claim 1 wherein:
receiving the plurality of such radio-frequency devices comprises receiving each such device in an enclosure; and
encoding the radio-frequency identification code is performed without removing the each of the radio-frequency devices from the enclosure.

6. The method recited in claim 5 wherein the package is the enclosure.

7. The method recited in claim 1 further comprising encapsulating the each of the radio-frequency devices in material to produce a structure of a standard size, wherein the preparation device is adapted to move objects of the standard size to the plurality of stations.

8. The method recited in claim 7 wherein encapsulating the each of the radio-frequency devices comprises heat shrink wrapping the each of the radio-frequency devices.

9. The method recited in claim 1 further comprising affixing the each of the radio-frequency devices to a backboard having a standard size, wherein the preparation device is adapted to move objects of the standard size to the plurality of stations.

10. The method recited in claim 1 further comprising inserting the each of the radio-frequency devices into an envelope for mailing to the recipient.

11. The method recited in claim 1 wherein receiving the plurality of such radio-frequency devices comprises receiving a reel that includes the plurality of such radio-frequency devices.

12. The method recited in claim 11 further comprising cutting the reel between radio-frequency devices to separate the radio-frequency devices.

13. The method recited in claim 1 further comprising:
receiving a plurality of magnetic-stripe cards;
reading, at a third station, an identification of each of the plurality of magnetic-stripe cards from a magnetic stripe comprised by the magnetic-stripe card; and
determining the radio-frequency identification code to be assigned to a corresponding one of the radio-frequency devices from the identification of the each of the plurality of magnetic-stripe cards,
wherein the package further contains the magnetic-stripe card corresponding to the each of the radio-frequency devices.

14. The method recited in claim 13 further comprising encapsulating the each of the radio-frequency devices in material to produce a structure of a standard size, wherein the preparation device is adapted to move objects of the standard size to the plurality of stations.

15. The method recited in claim 14 wherein the standard size is approximately equal to a size of the magnetic-stripe cards.

16. A method for automated preparation of radio-frequency devices for distribution, the method comprising:
receiving a plurality of such radio-frequency devices, each such device comprising an embedded radio-frequency transponder;
encapsulating each of the radio-frequency devices in material to produce a structure of a standard size; and
encoding a radio-frequency identification code assigned to the each of the radio-frequency devices through the encapsulating material.

17. The method recited in claim 16 further comprising:
reading the radio-frequency identification code from the each of the radio-frequency devices; and
verifying that the read radio-frequency identification code from the each of the radio-frequency devices matches the assigned radio-frequency identification code.

18. The method recited in claim 16 wherein encapsulating the each of the radio-frequency devices comprises heat shrink wrapping the each of the radio-frequency devices.

19. The method recited in claim 16 further comprising inserting the each of the encoded radio-frequency devices into a package labeled with an address of a recipient of the encoded radio-frequency devices.

20. A method for automated preparation of radio-frequency devices for distribution, the method comprising:
receiving a plurality of such radio-frequency devices, each such device comprising an embedded radio-frequency transponder;
affixing the each of the radio-frequency devices to a backboard having a standard size; and
encoding a radio-frequency identification code assigned to the each of the radio-frequency devices as the backboard is moved sequentially to a plurality of stations of a preparation device.

21. The method recited in claim 20 further comprising:
reading the radio-frequency identification code from the each of the radio-frequency devices; and
verifying that the read radio-frequency identification code from the each of the radio-frequency devices matches the assigned radio-frequency identification code.

22. The method recited in claim 20 further comprising inserting the each of the encoded radio-frequency devices into a package labeled with an address of a recipient of the encoded radio-frequency devices.

23. A method for automated preparation of radio-frequency devices for distribution, the method comprising:
receiving a plurality of such radio-frequency devices, each such device comprising an embedded radio-frequency transponder;
receiving a plurality of magnetic-stripe cards, each such magnetic stripe card having a magnetic-stripe identification encoded thereon;
sequentially moving pairs of the radio-frequency devices and magnetic-stripe cards to a plurality of stations of a preparation device;
encoding the radio-frequency device of each such pair with a radio-frequency identification code corresponding to the magnetic-stripe identification of the magnetic-stripe card of the each such pair at one or more of the stations; and
preparing the each such pair for mailing to a recipient at another of the stations.

24. The method recited in claim 23 further comprising:
reading the radio-frequency identification code from the radio-frequency device of the each such pair at a further station; and
verifying that the radio-frequency identification code corresponds to the magnetic-stripe identification of the magnetic-stripe card of the each such pair.

25. The method recited in claim 23 wherein preparing the each such pair for mailing comprises inserting the each such pair into an envelope addressed to the recipient.

26. A method for automated preparation of radio-frequency devices for distribution, the method comprising:
receiving a plurality of enclosures each holding a radio-frequency device, each such device comprising an embedded radio-frequency transponder;
sequentially moving each of the enclosures to a plurality of stations of a preparation device;
encoding, at a first station, a radio-frequency identification code assigned to the each of the radio-frequency devices without removing the each of the radio-frequency devices from its enclosure;
identifying a recipient for the each of the radio-frequency devices; and
labeling, at a second station, the enclosure of the each of the radio-frequency devices with an address for the recipient.

27. The method recited in claim 26 further comprising:
reading, at a third station, the radio-frequency identification code from the each of the radio-frequency devices; and
verifying that the read radio-frequency identification code matches the assigned radio-frequency identification code.

28. The method recited in claim 26 wherein each of the enclosures is a standard size.
